(19) United States
(12) Patent Application Publication
(10) Pub. No.: US 2018/0319439 A1
(43) Pub. Date: Nov. 8, 2018

(54) DEVICE TO ASSIST WITH MANEUVERS FOR PARKING ALONGSIDE A PLATFORM

(71) Applicant: NEWTL (SOCIÉTÉ PAR ACTIONS SIMPLIFIÉE), Duppigheim (FR)

(72) Inventors: Geoffrey RICHERT, Oberhausbergen (FR); Dominique BEBON, Weyersheim (FR)

(73) Assignee: NEWTL (SOCIÉTÉ PAR ACTIONS SIMPLIFIÉE), Duppigheim (FR)

(21) Appl. No.: 15/772,927

(22) PCT Filed: Oct. 27, 2016
(86) PCT No.: PCT/FR2016/052788

§ 371 Date: May 2, 2018

(30) Foreign Application Priority Data
Nov. 3, 2015 (FR) 1560531

(51) Int. Cl. B62D 15/02; B60Q 9/00; B60K 37/06; B60R 16/037; B62D 7/15; B62D 7/14

(52) U.S. Cl. CPC B62D 15/027; B62D 15/024; B60Q 9/00; B62D 7/142; B60R 16/0373; B62D 7/159; B60K 37/06

(57) ABSTRACT

The assistance device (I) operates in a road mode in which the rear wheels (9) are initially straight and, once the front wheels (II) have turned through a certain steering angle, the rear wheels (9) are controlled to steer proportionately to the steering angle control received by the front wheels (II). This device (I) also operates in a parking mode in which the rear axle (5) steers and in which the steering angle of the rear wheels (9) is controlled via a device (10) for controlling the steering of the rear axle (5). The device then controls the steering of the rear wheels (9), which is dependent on the distance between the vehicle and the platform and other obstacles in the environment. These distances are measured by distance sensors (15, 18, 17, 18).

### TECHNICAL DOMAIN

The present invention relates to a road vehicle with an assistance system for the berthing maneuvers at a pier.

The invention relates to any type of vehicle with articulated axles, in particular a road public transport vehicle, like a bus, including an appliance that helps the driver for the berthing maneuvers and the departure maneuvers at a pier, so that the vehicle does not collide with its environment and remains as close as possible to the pier at the end of the approach maneuver.

### STATE OF THE ART

In the domain of the special road transport vehicles, in particular for the logging trucks, it is well known to equip vehicles with steering axles that the driver can control for difficult maneuvers. Such appliances are usually controlled with a remote command, with the driver off the driver's cab to monitor the various movements of the axle from outside the vehicle.

Thus, such appliance is not suitable for driving in the urban environment, where leaving the driver's cab is particularly dangerous for the driver.

It is also well known to equip road vehicles with various sensors or cameras to help the driver for difficult maneuvers by providing visual or audio information about, notably, the presence, the position and the distance to obstacles around the vehicle.

At times, these sensors and cameras are coupled to an artificial intelligence to automatically monitor the front axle of the vehicle.

Thus, there are anti-collision devices and path correction devices that work on the front axle of the vehicle at great speed to prevent accidents.

There are also anti-collision devices and path correction devices for vehicles, where the wheels of the rear axle may be slightly turned with a steering angle visually less than 2° in absolute value. This very small steering angle does not help the driver for berthing maneuvers at low speed.

However, there is no sensor coupled to an artificial intelligence to automatically drive a rear steering axle of a road vehicle, in order to help the driver for low speed maneuvers, in particular for the berthing maneuvers at a pier.

Indeed, berthing maneuvers at a pier with a road public transport vehicle are often difficult in the urban environment. Since there are pedestrians, who may walk on places intended for buses, badly-parked cars that may intrude on such places at the bus stops, or various urban obstacles, it is sometimes difficult for the driver to achieve such approach and departure maneuvers at a pier, so that the vehicle does not collide with its environment and remain as close as possible to the pier at the end of the approach manoeuvre.

### DESCRIPTION OF THE INVENTION

Therefore, the object of the present invention is to address the drawbacks of the state of the art, by proposing a new road vehicle with an assistance system for the berthing maneuvers at a pier.

This assistance system works automatically when triggered. Thus, during the berthing maneuvers at a pier, the driver will not take care of the assistance system when triggered. The driver will drive the vehicle in a classical way, by turning the front steering axle in a classical way with the steering wheel, while the assistance system according to the invention turns a rear axle that is modified to be steering, without the driver taking care of it.

According to the invention, the wheels of the rear axle can be turned with a steering angle far more than 2°, for example more than 10°, preferably more than 20°, and even more preferably more than 30°.

A steering rear axle allows berthing maneuvers to the vehicle on a shorter distance, which is particularly beneficial with small reserved parking places for public transport vehicles.

This also makes it possible to position the rear of the vehicle as close to the pier as possible during the approach maneuvers, so that the vehicle is both as close as possible to the pier and perfectly parallel to it. This is particularly important for public transport vehicles that may carry passengers in a wheelchair, with strollers or shopping trolleys.

Another object of the present invention is to propose a new process of berthing at a pier for a road vehicle with the assistance system according to the invention.

According to a first variant of the invention, the objects of the invention are reached thanks to a road vehicle with front wheels mounted on a steering front axle and with rear wheels mounted on a rear axle, characterized in that it includes an assistance system for berthing maneuvers at a pier, and that the rear axle is a steering axle with a steering, the assistance system being designed to work according to a road mode or a berthing mode, and including the following means:
a directional steering system designed to monitor the deflection angle A_{AR} of the rear wheels;
a distance sensor at the rear of the vehicle, to measure the distance D_{ARp} from the rear of the vehicle to the pier;
wherein:
in road mode, either the wheels are straight ahead, or their deflection angle A_{AR} is monitored by the direction driving device based on the deflection angle A_{AV} of the front wheels;
in berthing mode, the driving system monitors the direction of the deflection angle of the rear wheels based on the distances as measured by the distance sensor and the angle of the front wheels A_{AV}.

Thus, the assistance system monitors the turn of the rear wheels totally automatically in order to optimize and facilitate the various maneuvers by the driver when berthing at a pier.

According to a second variant of the invention, the assistance system also includes the following means:
a distance sensor at the front to measure the distance D_{AVpier} from the front of the vehicle to the pier;
a distance sensor at the rear to measure the distance D_{ARenv} from the rear of the vehicle to the other obstacles in the environment;
   wherein:
in road mode, either the wheels are straight ahead, or their deflection angle A_{AR} is monitored by the direction driving device based on the deflection angle A_{AV} of the front wheels;
in berthing mode, the direction of the deflection angle of the rear wheels is monitored by the steering system based on the distances as measured by the distance sensors and the deflection angle A_{AV} of the front wheels.

Thus, thanks to additional distance measurements, the assistance system monitors the turn of the rear wheels with more optimization to facilitate the various maneuvers by the driver when berthing at a pier.

According to an implementation of the invention, the assistance system also includes a distance sensor at the front of the vehicle to measure the distance D_{AVenv} from the front of the vehicle to the other obstacles in the environment.

According to another implementation of the invention, the rear wheels can be turned according to an angle with an absolute value more than 10°, preferably more than 20° and more preferably more than 30°. This deflection angle, which is far more than angles of existing steering rear axles, optimizes the various berthing maneuvers in comparison with vehicles of the state of the art.

According to an implementation of the invention, in road mode, the directional steering system monitors the deflection angle A_{AR} of the rear wheels, so that the rear wheels are straight ahead in a first time, then, beyond a specific value of the deflection angle of the front wheels, the deflection of the rear wheels is controlled as a proportional and linear function of the steering command from the front wheels.

According to another implementation of the invention, in road mode, the rear axle is fixed with straight ahead rear wheels when the speed of the vehicle is faster than the maximum speed in road mode S_{VAR}. This prevents any risk of dangerous behavior of the vehicle above a given speed.

According to an implementation of the invention, the assistance system automatically switches from the berthing mode to the road mode when the speed of the vehicle is faster than the maximum berthing speed V_{MAXberthing} or when the deflection angle A_{AV} of the front wheels is more than a value α_{Outberthing} of the angle out of the pier. This prevents any risk of dangerous behavior of the vehicle above a given speed.

According to another implementation of the invention, the assistance system includes sensors to measure then deflection angle A_{AV} of the front wheels and the deflection angle A_{AR} of the rear wheels. These sensors give the necessary information for the function of the assistance system, in particular in road mode.

According to this implementation of the invention, when the front axle includes a steering gear, the deflection angle A_{AV} of the front wheels can be measured by an angle sensor that is connected to this steering gear.

Similarly, when the directional steering system includes a mobile rod actuator, the deflection angle A_{AR} of the rear wheels can be measured by a position sensor connected to the actuator of the directional monitoring device, while the deflection angle A_{AR} of the rear wheels is calculated based on the position of the actuator rod.

According to an implementation of the invention, the distance sensors are positioned on the right side of the vehicle, particularly if the vehicle should drive on the right side of the road.

According to another implementation of the invention, the distance sensors at the front of the vehicle are positioned in front of the front wheels, the distance sensor to the pier at the rear of the vehicle is positioned in front of the rear wheels, and the rear environmental sensor is positioned at the rear of the rear wheels. This way, the sensors are as close as possible to the obstacles they are designed to detect.

According to an additional implementation of the invention, the front and rear distance sensors information from the distance sensors are visually transmitted to the driver, which helps it drive.

According to an implementation of the invention, the assistance system includes a berthing/road mode switch that makes the assistance system change between the road mode and the berthing mode when triggered.

According to this implementation, the driver can activate the berthing/road mode switch thanks to a button provided inside the driver's cab of the vehicle.

The berthing/road mode switch can also be activated through a dialog without contact between the infrastructure and the vehicle. Thus, the driver won't have to care about activating the berthing/road mode switch: it will be automatic, for example when a vehicle draws near to or away from a pier equipped with a dialog system without any contact with the vehicle.

According to an implementation of the invention, the berthing/road mode switch does not allow the driver to change the assistance system from the road mode to the berthing mode as long as the vehicle drives faster than the maximum berthing speed V_{MAXberthing}. This prevents any risk of dangerous behavior of the vehicle above a given speed.

According to an implementation of the invention, the assistance system also includes an onboard intelligence that monitors the directional steering device to the rear axle.

For example, this onboard intelligence is connected to the distance sensors, to the sensors that measure the deflection angle A_{AV} of the front wheels and the deflection angle A_{AR} of the rear wheels, and to the berthing/road mode switch.

The onboard intelligence may include a memory to store the mathematical formulas as used in the assistance system to monitor the deflection angle of the rear wheels in road mode and berthing mode, and the constant values as used with these formulas.

The objects of the invention are also reached thanks to a berthing process to a pier, for a road vehicle as previously described, characterized in that it includes the following steps:
a) a driving phase, where the vehicle drives a classical way, where the assistance system is switched to road mode, and where the rear wheels are straight ahead or controlled by the front steering;
b) an approach phase, where the vehicle starts berthing to a pier, where the assistance system switches to the berthing mode with the rear wheels remaining in road mode as long as the distance sensor does not detect the pier, and where the rear wheels are controlled by the assistance system as soon as the distance sensor detects the pier, and are steered so that the rear axle is moved to the pier;
c) a stop phase, where the vehicle is berthed to the pier;
d) a start phase, when the vehicle is leaving the pier, where the assistance system switches to the berthing mode and the rear wheels are steered so that the rear axle is moved away from the pier;
e) a driving phase, where the vehicle drives a classical way after leaving the pier, with the assistance system switched to the road mode and the rear wheels straight ahead or controlled by the front steering.

According to this berthing process, during the stop phase, when the vehicle is berthed at the pier, the rear wheels can be monitored to come back to unturned position. Indeed, it brings the vehicle as close as possible to the pier, while turned wheels may impede the opening of the side doors of said vehicle.

This process makes berthing maneuvers much easier for the driver. The berthing is thus automatically optimized thanks to the assistance system, which allows the vehicle to berth parallel and close to a pier easier and more securely, with less space required than for classical vehicles.

Thanks to the invention, there is less gap between the vehicle and the pier, which makes it access easier. Since the distance to the pier is under control, the sides of the wheels no longer rub against it, which prevents their untimely wearing.

In addition, the required length for the berthing is reduced, which makes it possible to the vehicle to berth even if there is not enough space to do so for a classical vehicle.

By optimizing the duration and number of maneuvers required to berth, the invention also optimizes the fuel consumption of the vehicle.

At last, the sensors of the invention provide a visual driver assistance that does not depend on the weather and visibility.

### BRIEF DESCRIPTION OF THE ILLUSTRATIONS

Other characteristics and advantages of the present invention appear more clearly when reading the following description in reference to the appended illustrations; they are illustrative and do not restrict the invention:

FIG. 1 is a graph that shows the mathematical law yielding the deflection angle of the rear wheels based on the deflection angle of the front wheels, when the rear axle works in road mode;

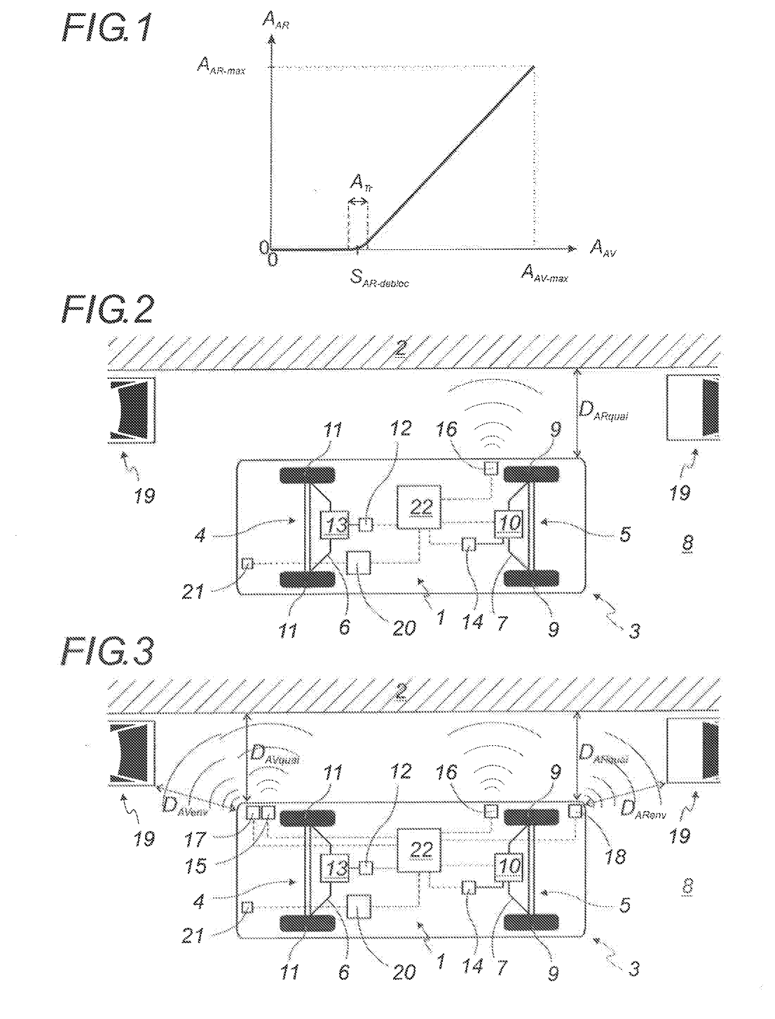

FIG. 2 is a schematic view of a vehicle with an assistance system for the berthing maneuvers at a pier according to a first variant of the invention;

FIG. 3 is a schematic view of a vehicle with an assistance system for the berthing maneuvers at a pier according to a second variant of the invention; and

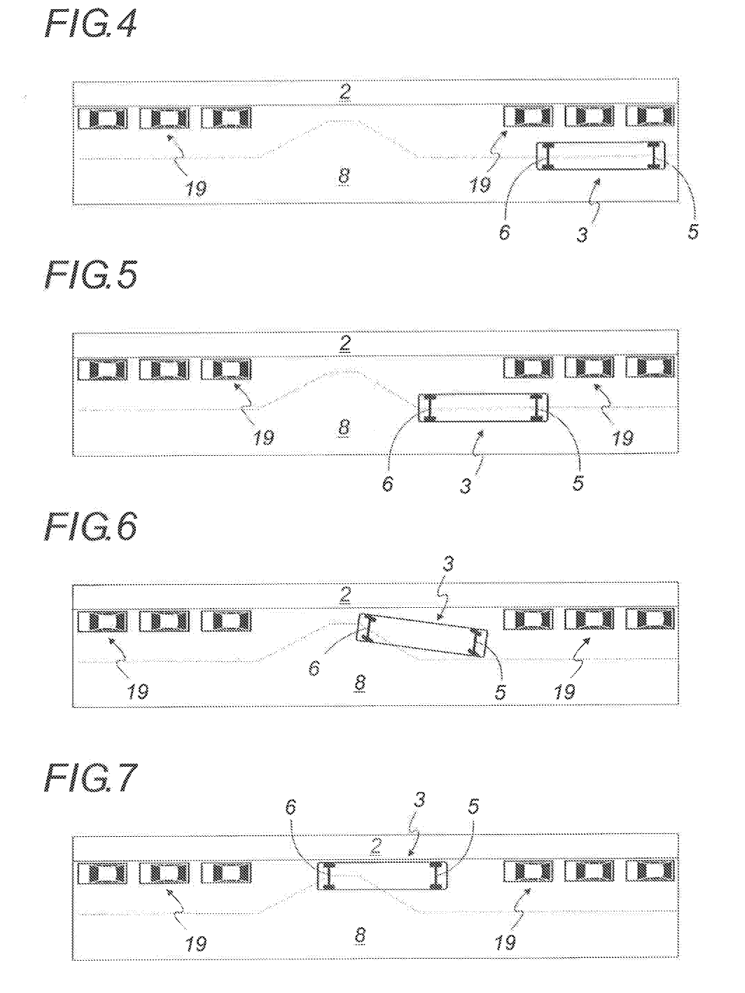

FIGS. 4 to 11 are schematic views of the approach maneuvers to and from a pier for a road vehicle with an assistance system according to the invention, where the trajectory of the axle is shown as a dotted line.

### MODE(S) OF IMPLEMENTATION OF THE INVENTION

Structurally and functionally identical items on several distinct figures are given the same numerical or alphanumerical reference.

The assistance system (1) for berthing maneuvers at a pier (2) according to the invention is designed for a road vehicle (3) with a steering front axle (4) equipped with a classical steering (6) monitored from the steering wheel (3) of the vehicle. The front steering (6) is, for example, assisted by a steering gear with variable hydraulic assistance (not figured).

Below in this description, by commodity, the word “pier” will describe any kind of edge, vehicle access concourse or any physical means, fixed or movable in reference to the ground, where travelers stand before entering a vehicle. Thus, the word “pier” shall not be considered in a limitative way, but as referring to any similar kind of edge.

The assistance system (1) of the invention is preferably designed for a road public transport vehicle (3), i.e. a bus, but may be adapted to any type of road vehicle (3).

The assistance system (1) according to the invention is also designed to make the rear axle (5) of a road vehicle (3) work under two modes, i.e. a road mode and a berthing mode. According to the invention, the rear axle (5) is a steering axle too and is equipped with a steering (7), but the driver of the road vehicle (3) does not monitor it. Indeed, the rear steering (7) is fully monitored by the assistance system (1) according to the invention.

In order to monitor the deflection angle of the rear wheels (9) in both function modes, the assistance system (1) according to the invention includes a directional steering system (10) of the rear axle (5). This directional steering system (10) includes an actuator, preferably as a hydraulic actuator coupled with a proportional valve or as an electric actuator.

As a rule, in road mode, the rear wheels (9) are straight ahead firstly, then, beyond a given deflection angle value of the front wheels (11), the deflection of the rear wheels (9) is proportionally controlled in reference to the steering command from the front wheels (11).

According to a less beneficial variant of the invention, in road mode, the rear wheels (9) are always straight ahead, like for a classical vehicle.

“Straight ahead” wheels are wheels that are not deflected—wheels whose deflection angle is 0°, aligned with the longitudinal direction of the vehicle.

In berthing mode, the deflection angle of the rear wheels (9) is monitored by the assistance system (1) as a function of the distances from the vehicle (3) to the pier (2) and to the other obstacles in the environment.

Both function modes of the assistance system (1) of the invention will be described more in detail hereafter.

### Road Mode

In road mode, the rear axle (5) is designed for the normal driving of the vehicle (3) on the road (8) based on a maximum speed abiding by the speed limitations of the traffic regulations. In this mode, the rear wheels (9) are steered according to the position of the front wheels (11) under a mathematical law based on the deflection angle of the front wheels (11). This mathematical law that rules the road mode is depicted in the FIG. 1.

In road mode, the vehicle (3) can drive at a speed, whose value is incompatible with the necessary maneuvers when berthing to a pier (2). For example, although it is not forbidden by the traffic regulations, a vehicle (3) cannot reasonably berth at a pier at 50 km/h.

In road mode, the rear wheels (9) are straight ahead until the front wheels (11) are deflected right or left beyond a given angle, called unlocking threshold S_{ARdebloc}, where the assistance system (1) according to the invention automatically turns the rear wheels (9) by a deflection angle that is proportional to the deflection angle of the front wheels (11).

Thus, as displayed in the FIG. 1, when the deflection angle A_{AV} of the front wheels (11) reaches the threshold value S_{ARdebloc}, the wheels (9) of the rear axle (5) also turn by an angle A_{AR} that is proportional to the deflection angle A_{AV} of the front wheels (11).

According to a preferential implementation of the invention, the rear wheels (9) are progressively steered by the front wheels, which results in a curve at the transition between the straight-ahead position of the rear wheels (9) and their state as steered by the front wheels. This transition results from a 2^{nd} degree polynomial law.

See the mathematical laws that rule the road mode:

$$If \vert {A}_{AV} \vert < {A}_{AVmax} \times {S}_{ARdebloc} - \frac{1}{2} {A}_{Tr} , then$$

$${A}_{AR} = 0$$

$$If \vert {A}_{AV} \vert \geq {A}_{AVmax} \times {S}_{ARdebloc} - \frac{1}{2} {A}_{Tr} , then$$

$${A}_{AR} = {k}_{x} \times sign ( {A}_{AV} ) \times {( \vert {A}_{AV} \vert - {A}_{AVmax} \times {S}_{ARdebloc} - \frac{1}{2} {A}_{Tr} )}^{2}$$

$$If \vert {A}_{AV} \vert \geq {A}_{AVmax} \times {S}_{ARdebloc} + \frac{1}{2} {A}_{Tr} , then$$

$${A}_{AR} = {A}_{AR \text{-} max} \times sign ( {A}_{AV} ) \times \frac{\vert {A}_{AV} \vert - {A}_{AV \text{-} max} \times {S}_{AR \text{-} debloc}}{{A}_{AV \text{-} max} - {A}_{AV \text{-} max} \times {S}_{AR \text{-} debloc}}$$

$$with$$

$${k}_{{x}^{2}} = \frac{\frac{{A}_{AR \text{-} max} \times {A}_{Tr}}{2 \times ( {A}_{AV \text{-} max} - {A}_{AV \text{-} max} \times {S}_{AR \text{-} debloc} )}}{{A}_{Tr}^{2}}$$

where the terms have the following meanings:
A_{AV} steering angle of the front wheels (11), in degrees
A_{AVmax} maximum steering angle of the front wheels (11), in degrees
A_{AR} steering angle of the rear wheels (9), in degrees
A_{ARmax} maximum steering angle of the rear wheels (9), in degrees
A_{Tr} angular range for the transition, in degrees
S_{ARdebloc} unlocking threshold of the rear wheels (9), in percentage

In the context of this description, it is considered a 0° steering angle of the wheels means straight ahead wheels, which are aligned with the longitudinal axis of the vehicle.

The maximum steering angle A_{ARmax} of the rear wheels (9) intrinsically depends on the vehicle (3) and its design. It generally ranges between −35° and a +35°.

The steering angle A_{AV} of the front wheels (11) is preferably measured by an angle sensor (12) that is connected to the steering gear (13) of the front axle (4) while the steering angle A_{AR} of the rear wheels (9) is preferably measured by a position sensor (14) that is connected to the actuator of the directional steering system (10) to measure the linear movement. The position sensor (14) computes the steering angle A_{AR} of the rear wheels (9) as a function of the position of the actuator rod thanks to a PID controller.

According to a (not shown) implementation of the invention, the steering angle A_{AV} of the front wheel (11) is measured by an angle sensor inside the swivel of at least one of the front wheels (11), while the steering angle A_{AR} of the rear wheel (9) is measured by an angle sensor inside the swivel of at least one of the rear wheels (9).

The transition angle A_{Tr} ranges between 0° and 40°. The default value is 6°, but it can be empirically tuned by tests in real conditions for each type of vehicle (3).

The unlocking threshold S_{ARdebloc} of the rear wheels (9) is selected according to the desired steering degree for the rear axle (5). The lower the threshold S_{ARdebloc}, the more the driver may feel that the back of the vehicle (3) goes adrift. On the contrary, the higher the threshold S_{ARdebloc}, the more the driver feels like in a classical vehicle without an assistance system (1) for the berthing maneuvers, and the more the steering wheel shall move. The threshold S_{ARbloc} of the rear wheels (9) is preferably selected at 25%. Its definitive value retained may be empirically enhanced by tests in real conditions for each type of vehicle (3).

In road mode, it is also possible to have the rear wheels (9) controlled thanks to a modified mathematical law that takes the speed of the vehicle (3) into account.

According to this modificative mathematical law, the steering angle A_{AR} of the rear wheels (9) is multiplied by a coefficient kᵥᵢₜ that depends on the speed of the vehicle according to the following formulas:

A′_{AR}=A_{AR}×kᵥᵢₜ

with

kᵥᵢₜ=max(0; min(1; (Fᵥ×V)+(−Sᵥₐᵣ×pᵥ))

where the terms have the following meanings:
A_{AR} steering angle of the rear wheels (9), in degrees, computed according to the previous mathematical law
A′_{AR} steering angle of the rear wheels (9), in degrees, taking the speed into account
A_{AV} steering angle of the front wheels (11), in degrees
pᵥ slope of the speed control between −1 and 0
Sᵥₐᵣ maximum speed in road mode, in km/h
V speed of the vehicle, in km/h

The maximum speed in road mode Sᵥₐᵣ is the maximal speed, above which the rear axle (5) is fixed with straight ahead (0°) rear wheels (9) when the assistance system (1) is in road mode. Indeed, above a given speed of the vehicle (3), it is assumed dangerous that the rear axle (5) be steering, because this could induce instability to the vehicle (3) at the rear in a curve. The default maximum speed in road mode Sᵥₐᵣ is 40 km/h in an urban environment but may be empirically enhanced by tests in real conditions for each type of vehicle (3), taking into account the peculiarities of the scheduled path.

The slope of the speed control amounts between −1 and 0. The default value is −0.1 but may be empirically enhanced by tests in real conditions for each type of vehicle (3).

### Berthing Mode

In berthing mode, the rear axle (5) is designed to facilitate the berthing of a vehicle (3) at low speed to the pier (2). In this mode, the assistance system (1) of the invention automatically monitors the steering of the wheels (9) of the rear axle (5) with a wide angle that optimizes the berthing of the vehicle (3) against the pier (2).

In berthing mode, the vehicle (3) must drive at low speed compatible with the required maneuvers when berthing to a pier (2). Indeed, when a vehicle berths at a pier, it generally drives slowly to prevent any collision with the environment.

This reduced speed also guarantees the security of the assistance system (1) in case of malfunction.

In order to optimize the berthing of the vehicle (3), the assistance system (1) according to the invention includes various sensors that make it possible to localize the vehicle (3) inside the environment, in particular in reference to the other vehicles and to the pier (2) where the driver wants to berth.

It should be noted that some piers are not equipped with specific edges. Thus, a pier may have the same height as a sidewalk, and it is not possible to distinguish a pier (2) from a sidewalk from the height. For other piers (2), on the contrary, the sidewalk can be higher or lower than the pier (2).

According to a first variant of the invention as displayed in the FIG. 2, the assistance system (1) includes at least one distance sensor (16) at the rear of the vehicle (3) that is designed to detect and specifically measure the distance D_{ARpier} from the rear of the vehicle (3) to the pier (2).

According to a second variant of the invention as displayed in the FIG. 3, the assistance system (1) also includes at least one distance sensor (17) at the front and at least one distance sensor (18) at the rear of the vehicle, each one being designed to detect and measure the distance D_{AVenv}, D_{ARenv} to the other obstacles in the environment (cars, pedestrians, etc.) According to this second variant of the invention, the assistance system (1) also includes at least one distance sensor (15) at the front of the vehicle (3) and designed to detect and specifically measure the distance D_{AVpier} to the pier (2) in front of the vehicle (3).

The distance sensor (17) to the environment at the front is optional, because the assistance system (1) according to the invention does not take this distance into account to monitor the steering of the rear wheels (9) and the driver does not need this information if the visibility is good, for it can assess it by itself from the driver's cab.

In these two variants of the invention, the distance sensors (15, 16, 17, 18) can be of any type. So, they can be radar, laser, infrared, ultrasound or optical devices, such as cameras.

Similarly, in these two variants, in addition to the measurement of the distance from the pier (2) to the vehicle (3), the distance sensors (15, 16) to the pier can also be provided to measure the height of obstacles, in particular the height of the pier (2). For example, in the case of road public transport vehicles, it makes it possible to adjust the height of the vehicle (3) in reference to the height of the pier (2) so that the level of the floor of the vehicle (3) is the same as the pier (2).

Thus, it might be possible to use distance sensors (15, 16) to the pier, or other specific sensors, to measure the height of the pier, so that the vehicle (3) can adjust its height and/or deploy an access platform, if necessary, and the passengers get in and out the vehicle. For example, this adjustment of the height of the vehicle (3) is made by acting on the suspension. The height adjustment of the vehicle (3) can be automatic during the stop phase of the vehicle (3) and/or can be manually triggered by the driver or the passengers, for example thanks to a button outside the vehicle to be accessible to any disabled in a wheelchair.

In the case of the second variant of the invention, the distance sensors (15, 17) provided at the front of the vehicle (3) not only measure the distance D_{AVpier} from the front of the vehicle (3) to the pier (2) and the distance D_{AVenv} from the front of the vehicle (3) to the other obstacles in the environment to optimize the monitoring of the steering of the rear wheels (9), but also help the driver. Indeed, thanks to a progressive—preferably visual—information feedback, the driver can optimize the position of the front wheels (11) that he monitors thanks to the steering wheel of the vehicle (3).

Thanks to the information from the distance sensors (16, 18) and from the angle sensors (14) of the wheels at the rear of the vehicle (3), the driver also receives information about the steering angle A_{AR} of the rear wheels (9), about the distance D_{ARpier} from the rear of the vehicle (3) to the pier (2) and about the distance D_{ARenv} from the rear of the vehicle (3) to the other obstacles in the environment, for even more optimization of the berthing.

In the case of the second variant of the invention, at the front and the rear, the same distance sensor can fulfill at the same time the function of a distance sensor (15, 16), to detect and specifically measure the distances D_{ARpier} and D_{AVpier} to the pier (2), and of a sensor (17, 18) to detect and measure the distances D_{ARenv} and D_{AVenv} to the other obstacles in the environment.

Most of the time, however, those are distinct distance sensors, because the sensors (15, 16) designed to detect and specifically measure the D_{ARpier} and D_{AVpier} to the pier (2) that may not be at the same height on the vehicle (3) as the sensors (17, 18) designed to detect and measure the distance D_{ARenv} and D_{AVenv} to the other obstacles in the environment. Thus, the sensors (15, 16) designed to detect and specifically measure the D_{ARpier} and D_{AVpier} to the pier (2) can be provided lower than the sensors (17, 18) provided to detect and measure the distance D_{ARenv} and D_{AVenv} to the other obstacles in the environment.

In fact, some obstacles in the environment, i.e. such as the body frame of a car (19) on the road (8), may be higher than the pier (2) but may not touch the ground; they would not be detected by a distance sensor positioned too low, while other obstacles in the environment may be standing lower than the pier (2) and would not be detected by a distance sensor positioned too high.

According to another variant of the invention, redundant sensors (15, 16, 17, 18) may be considered, i.e. with distance sensors (17, 18) to the environment and/of distance sensors (15, 16) to the pier both at the front and the rear of the wheels (9, 11) of the vehicle (3).

For a road public transport vehicle designed to drive on the right side of the road (8), the distance sensors (15, 16, 17, 18) according to the invention are positioned on the right side of the vehicle (3).

Preferably, the front distance sensors (15, 17) of the invention are positioned in front of the front wheels (11), while the rear distance sensor to the pier (16) is positioned in front of the rear wheels (9) and the rear distance sensor to the environment (18) is positioned behind the rear wheels (9).

The distance sensors to the pier (15, 16) are preferably provided on front of the wheels (9, 11), because vehicles (3) generally berth moving forward.

The distance sensors to the environment (17, 18) are preferably provided at the front and back ends of the vehicle (3) to be as close as possible to the environmental obstacles they should detect.

In addition to the distance sensor of the rear environment (18), a second optional sensor (not figured) of the same kind may be positioned in front of the rear wheels (9) to improve the accuracy of the environmental detection.

As a rule, distance sensors (15, 16, 17, 18) are provided on the vehicle (3) in order to ideally detect and localize the obstacles, so that the road vehicle (3) does not collide with its environment and, during the approach phase to the pier (2), the steering angle A_{AR} of the rear wheel (9) is optimized, so that the wheels (9, 11) of the vehicle (3) do not collide with the pier (2), the back of the vehicle (3) does not come close to the pier (2) faster than the front of the vehicle (3), and the vehicle (3) is parallel to the pier (2) at the end of the approach phase, with the front axle (6) and the rear axle (5) as close as possible to the pier (2).

The distance information that are received by distance sensors (15, 16, 17, 18) at the front and at the rear of the vehicle (3) are transmitted to the driver, preferably visually and not by audio because of the ambient noise as usual in public transport vehicles. This way, the driver follows in real time the position of its vehicle (3) in reference to the pier (2) and the environment.

The distance sensors D_{ARpier}, D_{AVpier}, D_{ARenv} and D_{AVenv} are preferentially provided with a detection range between 0 and 1.5 m.

For both variants of the invention, the assistance system (1) according to the invention also includes a berthing/road mode switch (20) that makes the assistance system (1) change between the road mode and the berthing mode when triggered.

This berthing/road mode switch (20) is preferably manually activated thanks to a button (21) provided inside the driver's cab of the vehicle (3), which allows the driver to switch the assistance system (1) by itself between the road mode and the berthing mode.

According to a variant of the invention, the berthing/road mode switch (20) can also be activated through a dialog without contact between the infrastructure (ground, pier, tag, etc.) and the vehicle (3).

For security reasons mentioned above, this berthing/road mode switch (20) does not change the assistance system (1) from the road mode to the berthing mode as long as the vehicle drives at a speed matching the road mode. Indeed, the assistance system (1) won't turn by accident to the road mode when in berthing mode if the vehicle is driving at a speed where it would be dangerous, and the assistance system (1) automatically switches to road mode in case of overspeed.

So, the berthing/road mode switch (20) prevents changing to the berthing mode as long as the vehicle drives faster than the maximum berthing speed V_{MAXberthing}.

In addition, when the speed of the vehicle (3) is faster than the maximum berthing speed V_{MAXberthing}, the assistance system (1) automatically switches to the road mode.

The default maximum berthing speed V_{MAXberthing} is 25 km/h but may be empirically tuned by tests in real conditions for each type of vehicle, taking into account the peculiarities of the scheduled path.

At last, as schematically displayed at the FIGS. 2 and 3, the assistance system (1) according to the invention also includes an onboard intelligence (22), which is notably connected with all sensors (12, 14, 15, 16, 17, 18) of the invention, with the directional steering system (10) of the rear axle (5) and with the berthing/road mode switch (20).

This onboard intelligence (22) notably includes a memory (not figured), where the mathematical formulas are stored as used by the assistance system (1) according to the invention along with the constant values as used with these formulas. Of course, means (not figured) are provided to input and change these mathematical formulas and these constants in the onboard intelligence (22), no matter directly or remotely.

The onboard intelligence (22) may include means (not figured) to transmit information to the driver, preferably visually.

Preferably, the assistance system (1) according to the invention also includes a survey appliance (not figured) of the rear axle (5) designed to detect any abnormality on it, i.e. electronic failure, hydraulic failure, general function default, inconsistencies, etc. if an abnormality is detected, the rear axle (5) is secured with the rear wheels (3) fixed in central position parallel to the longitudinal axis of the vehicle.

It should be noted that the first variant of the invention, which includes only one distance sensor (16) at the pier (2) at the rear of the vehicle (3), is a basic and simplified version of the invention, while the second variant of the invention, which includes many other distance sensors (15, 17, 18) is a more elaborate and complex version of the invention. Thus, the first variant of the invention is less expensive than the second one, but also provides some less optimized help to the driver during the approach and departure maneuvers at a pier (2).

Now, we will focus on the function of the assistance system (1) for the berthing maneuvers at a pier (2) according to these two variants of the invention during the different phases of a berthing.

### Driving Phase

When the vehicle (3) drives at a normal speed to move quickly from a place to another, the assistance system (1) according to the invention switches to the road mode. The rear wheels (9) are straight ahead, like in a classical vehicle (FIG. 4) or steered in position to the front wheels (11) if the driver steers the front wheels (11) beyond a given steering angle S_{ARdebloc}.

### Approach Phase (for the First Variant)

During the approach phase of the berthing to a pier (2), the driver drives the vehicle (3) slowly and the assistance system (1) according to the invention is switched to berthing mode.

Thus, the approach phase is launched when the vehicle is driving slower than the maximum berthing speed V_{MAXberthing} and the driver has manually triggered the berthing/road mode switch (20) to change the assistance system from road mode to berthing mode.

The rear axle (5) is controlled so that it gets closer to the pier (2) as long as the rear distance sensor (16) has not detected the pier (2) (FIGS. 4 and 5). At this moment, the steering angle A_{AR} of the wheels (9) of the rear axle (5) is proportional to the steering angle A_{AV} of the wheels (11) of the front axle (4) multiplied by an angular ratio R_{BerthingSimpl} as specified in the following formula:

A_{AR}=A_{AV}×R_{BerthingSimpl}

The angular ratio R_{BerthingSimpl} preferably ranges between 0 and 10. Its default value is 2 but it can be empirically tuned by tests in real conditions for each type of vehicle.

When the rear distance sensor (16) detects the pier (2), the rear axle (5) is monitored in berthing mode and the rear wheels (9) are steered, so that the rear axle (5) comes as close as possible to the pier (2) without cold icing with it (FIG. 6). This function may induce crab steering.

The steering of the rear wheels (9) is adapted according to the distance D_{ARpier} from the back of the vehicle (3) to the pier (2), so that the wheels (9, 11) of the vehicle (3) do not collide with the pier (2).

The steering angle A_{AR} of the rear wheels (3) is computed as a function of the distance measured above according to the following formula:

A_{AR}=min(A_{AV}×R_{BerthingSimpl}; f(D_{ARpier}))

where f(D_{ARpier}) is a 2^{nd} degree polynomial law, such as:

(a_{pierAR}×x²)+(b_{pierAR}×x)+c_{pierAR}

The terms in the above formula can be empirically tuned by tests in real conditions for each type of vehicle (3), taking into account the peculiarities of the place where the vehicle will have to manoeuvre.

The default values of these parameters are:
a_{pierAR}=−0.0306
b_{pierAR}=6.381
c_{pierAR}=−44

### Approach Phase (for the Second Variant)

During the approach phase of the berthing to a pier (2), the driver drives the vehicle (3) slowly and the assistance system (1) according to the invention is switched to berthing mode.

The wheels of the rear axle (5) remain monitored in road mode as long as the front distance sensor (15) does not detect the pier (2) (FIG. 5).

When the front distance sensor (15) detects the pier (2), the rear axle (5) is monitored in berthing mode and the rear wheels (9) are steered, so that the rear axle (5) comes as close as possible to the pier (2) (FIG. 6).

This function may induce crab steering of the vehicle (3) if the environment makes it possible, or it may have the vehicle move in a more conventional way to avoid obstacles.

The steering of the rear wheels (9) is tuned according to the following measure values:
the distance D_{ARenv} from the back of the vehicle (3) to the other obstacles in the environment, so that the vehicle (3) does not collide with the environment;
the distance DARₚᵢₑᵣ from the back of the vehicle (3) to the pier (2), so that the wheels (9 11) of the vehicle (3) do not collide with the pier (2);
the distance D_{AVpier} from the front of the vehicle (3) to the pier (2), so that the back of the vehicle (3) does not come close to the pier (2) faster than the front of the vehicle (3).

Thus, the steering angle A_{AR} of the rear wheels (9) is computed as a function of the three measured distance values above according to the three following formulas:

A_{AR}=min(f(D_{ARenv}); f(D_{ARpier}); f(D_{AVenv}))

where f(D_{ARenv}) is a 2^{nd} degree polynomial law, such as:

(aₑₙᵥ×x²)+(bₑₙᵥ×z)+cₑₙᵥ

and f(D_{ARpier}) is a 2^{nd} degree polynomial law, such as:

(a_{pierAR}×x²)+(b_{pierAR}×x)+c_{pierAR}

and f(D_{AVpier}) is a 1^{st} degree polynomial law, such as:

a_{pierAV}×(D_{AVpier}−D_{ARpier})+b_{pierAV}

The various factors in the three formulas above depend on each other and are intrinsically linked to the type of vehicle (3) equipped with the assistance system (1) according to the invention.

These factors can be empirically tuned by tests in real conditions for each type of vehicle (3), taking into account the peculiarities of the place where the vehicle will have to manoeuvre.

The default values of these factors are:
aₑₙᵥ=0
bₑₙᵥ=4.4
cₑₙᵥ=−50
a_{pierAR}=−0.0305
b_{pierAR}=6.381
c_{pierAR}=−44
a_{pierAV}=0.5
b_{pierAV}=0

### Stop Phase (for Both Variants)

When the vehicle (3) is berthed at the pier (2), it stops on place. It's temporarily entering a stop phase.

In the case of a public transport vehicle, it is the moment when the driver allows the opening of the doors.

In the stop phase, the rear wheels (9) are preferably monitored to be straight ahead, so that they are as close as possible to the pier (2), but this may increase the wearing of the tires. So, this straight ahead orientation of the rear wheels (9) may be optional.

The vehicle (3) stands as close as possible to the pier (2) both at the front and the rear to allow the passengers to get on and off the bus easier (FIG. 7).

### Start Phase (for Both Variants)

When all passengers got in or out, the vehicle (3) can leave the pier (2).

In the case of a public transport vehicle, it is the moment when the driver shuts the doors, which launches the start phase. For obvious security reasons, this phase can only be effective when the doors are closed and locked.

So, the rear axle (5) remains locked with the rear wheels (9) preferably straight ahead as long as the doors are not locked.

Once all doors locked, traction is available again for the driver to leave to pier (2).

The assistance system (1) according to the invention switches to the berthing mode.

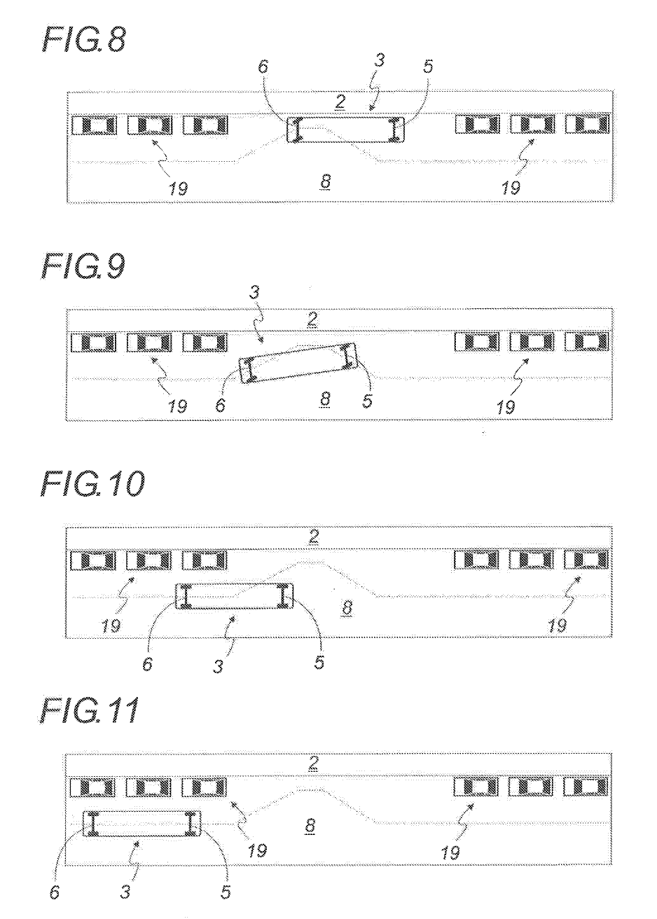

During this start phase, the assistance system (1) according to the invention makes it impossible to the rear axle (5) to steer the rear wheels (9) to the pier (2). The rear wheels (9) are indeed steered in the opposite direction (FIG. 8) proportionally to the steering command received by the wheels (11) of the front axle (4) according to the following formula:

A_{AR}=A_{AV}×k_{départ}

where k_{départ} is a proportionality percentage, in percent.

By default, the value of k_{départ} is selected at 20%. Here again, this value can be empirically tuned.

According to a variant of the invention, during the start phase, the rear wheels (9) are not steered proportionally to the steering command received by the wheels (11) of the front axle (4) but according to a fixed steering angle, i.e. 5° to the left.

According to another variant of the invention, the rear wheels (9) are steered the same way as for the approach phase, but in the opposite direction. So, the rear axle (5) leaves the pier (2) as fast as possible without ever colliding with its environment and without getting away from the pier (2) faster than the front axle (6).

### Driving Phase (for Both Variants)

When the vehicle (3) has left the pier (2) (FIG. 9), the start phase is over and the assistance system (1) according to the invention switches to the road mode (FIG. 10). The vehicle is back in driving phase (FIG. 11).

Once the vehicle (3) has finished its start phase, the switching of the assistance system (1) according to the invention to the road mode can be manual by the driver thanks to the berthing/road mode switch (20), automatic when the speed of the vehicle (3) is faster than the maximum berthing speed V_{AVBerthing} (default value 10 km/h) or automatic when the steering angle A_{AV} at the front wheel (11) to the right is larger than an angle α_{OutBerthing} out of the pier.

The value of the angle α_{OutBerthing} out of the pier can be an absolute angular value or in percentage of the maximum steering angle of the front wheels (11) A_{AVpier}. This angle α_{OutBerthing} is preferably 5° to the right. This value can be empirically tuned.

### Reverse Gear (for the First Variant)

The assistance system (1) for the berthing maneuvers at a pier (2) according to the first variant of the invention is also designed to be used with the reverse gear of the vehicle (3) for all the driving modes of the rear axle (5).

In driving phase, the assistance system (1) is in road mode and no change of the driving rule is necessary.

In approach phase, as long as the rear distance sensor (16) does not detect the pier (2), the driving rule is not modified. As soon as the rear distance sensor (16) detects the pier (2), the driving rule is reversed, which means that the rear wheels (9) are monitored to come close to the pier without ever colliding with it.

In stop phase and start phase, the driving rule is reversed like above.

### Reverse Gear (for the Second Variant)

The assistance system (1) for the berthing maneuvers at a pier (2) according to the second variant of the invention is also designed to be used with the reverse gear of the vehicle (3) for all the driving modes of the rear axle (5).

In driving phase, the assistance system (1) is in road mode and no change of the driving rule is necessary.

In approach phase, as long as the front distance sensor (15) does not detect the pier (2), the driving rule is not modified. As soon as the front distance sensor (15) detects the pier (2), the driving rule is reversed, which means that the rear wheels (9) are monitored to come close to the pier without ever colliding with it.

In stop phase and start phase, the driving rule is reversed like above.

It is obvious that the present description is not restricted to the explicit examples but also encompasses other modes of realization and/or implementation. So, a technical characteristic as described may be replaced by an equivalent technical characteristic without departing from the frame of the present invention, and a step of implementation of the process may be replaced by an equivalent step without departing from the frame of the present invention as described in the claims.

1-21. (canceled)

22. A road vehicle (3) including front wheels (11) mounted on a steering front axle (4) and rear wheels (9) mounted on a rear axle (5), wherein the vehicle (3) includes an assistance system (1) for berthing maneuvers at a pier (2) and the rear axle (5) is steerable and equipped with a steering (7), and the assistance system (1) is designed to work according to either a road mode or a berthing mode, and includes:
a directional steering system (10) designed to monitor a steering angle (AAR) of the rear wheels (9);
a distance sensor (18) provided at a rear of the vehicle (3) to measure a distance (DARpier) from the rear of the vehicle (3) to the pier (2);
wherein:
in the road mode, the rear wheels (9) are either straight ahead or their steering angle (AAR) is monitored by the directional steering system (10) based on a steering angle (AAV) of the front wheels (11); and
in the berthing mode, the steering angle of the rear wheels (9) is monitored by the directional steering system (10) based on distances measured by the distance sensor (16) and on the steering angle (AAV) of the front wheels (11).

23. The road vehicle (3) according to the claim 22, wherein the assistance system also includes:
a distance sensor (15) provided at a front to measure a distance (DAVpier) from the front of the vehicle (3) to the pier (2);
a distance sensor (18) provided at the rear of the vehicle (3) to measure a distance (DARenv) from the rear of the vehicle (3) to other environmental obstacles;
wherein:
in the road mode, either the rear wheels (9) are straight ahead, or their deflection angle (AAR) is monitored by the direction driving device (10) based on the deflection angle (AAV) of the front wheels (11);
in the berthing mode, the steering angle of the rear wheels (9) is monitored by the direction driving device (10) based on the distances measured by the distance sensors (15, 16, 18).

24. The road vehicle (3) according to claim 22, wherein the assistance system also includes a distance sensor (17) provided at the front of the vehicle (3) to measure a distance (DAVenv) from the front of the vehicle (3) to other environment obstacles.

25. The road vehicle (3) according to claim 22, wherein the rear wheels (9) can be steered with an angle, whose absolute value is greater than 10°.

26. The road vehicle (3) according to claim 22, wherein in the road mode, the direction driving device (10) monitors the deflection angle (AAR) of the rear wheels (9) so that the rear wheels (9) are initially straight ahead, then, beyond a given value of the steering angle of the front wheels (11), the deflection of the rear wheels (9) is controlled as a proportional and a linear function of the steering command from the front wheels (11).

27. The road vehicle (3) according to claim 22, wherein, in the road mode, the rear axle (5) is fixed with straight ahead rear wheels (9) when the speed of the vehicle (3) is greater than a maximum speed in the road mode (SVAR).

28. The road vehicle (3) according to claim 22, wherein the assistance system (1) automatically switches from the berthing mode to the road mode when the speed of the vehicle is greater than a maximum berthing speed (VMAXberthing) or when the deflection angle (AAV) of the front wheels (11) is more than a value (OutBerthing) of the angle out of the pier.

29. The road vehicle (3) according to claim 22, wherein the assistance system (1) includes sensors that make measuring of the deflection angle (AAV) of the front wheels (11) and the deflection angle (AAR) of the rear wheels (9) possible.

30. The road vehicle (3) according to claim 29, wherein the front axle (4) includes a steering gear (13), and the deflection angle (AAV) of the front wheels (11) is measured by an angle sensor (12) that is connected to this steering gear (13).

31. The road vehicle (3) according to claim 29, wherein the direction driving device (10) includes a mobile rod actuator and the deflection angle (AAR) of the rear wheels (9) is measured by a position sensor (14) connected to the actuator of the directional monitoring device (10), while the deflection angle (AAR) of the rear wheels (9) is calculated based on a position of the actuator rod.

32. The road vehicle (3) according to claim 22, wherein the distance sensors (15, 16, 17, 18) are positioned on the right side of the vehicle (3).

33. The road vehicle (3) according to claim 22, wherein the distance sensors (15, 17) provided at the front of the vehicle (3) are positioned in front of the front wheels (11), the distance sensor to the pier (18) provided at the rear of the vehicle (3) is positioned in front of the rear wheels (9) and the distance sensor to the environment (18) is positioned behind the rear wheels (9).

34. The road vehicle (3) according to claim 22, wherein the distance information from the front and the rear, that are received by the distance sensors (15, 16, 17, 18), are visually transmitted to the driver.

35. The road vehicle (3) according to claim 22, wherein the assistance system (1) includes a berthing/road mode switch (20) which, when triggered, makes the assistance system (1) change between the road mode and the berthing mode.

36. The road vehicle (3) according to claim 35, wherein the berthing/road mode switch (20) is manually activated by the driver by a button (21) provided inside a driver's cab of the vehicle (3) or is activated through dialog without contact between an infrastructure and the vehicle (3).

37. The road vehicle (3) according to the claim 35, wherein the berthing/road mode switch (20) does not allow the driver to change the assistance system (1) from the road mode to the berthing mode as long as the vehicle (3) is driving faster than a maximum berthing speed (VMAXberthing).

38. The road vehicle (3) according to claim 22, wherein the assistance system (1) also includes an onboard intelligence (22) that monitors the directional steering device (10) to the rear axle (5).

39. The road vehicle (3) according claim 29, wherein the assistance system (1) includes a berthing/road mode switch (20), the onboard intelligence (22) is connected to the distance sensors (15, 16, 18), to the sensors that measure the deflection angle (AAV) of the front wheels (11) and the deflection angle (AAR) of the rear wheels (9), and to the berthing/road mode switch (20).

40. The road vehicle (3) according to the claim 39, wherein the onboard intelligence (22) includes a memory to store mathematical formulas used in the assistance system (1) for monitoring the deflection angle of the rear wheels (9) in the road mode and the berthing mode, and constant values used with these formulas.

41. The berthing process to a pier for a road vehicle (3) according to claim 22, wherein the berthing process includes:
a) a driving phase, where the vehicle (3) drives in a classical way, where the assistance system (1) is switched to the road mode, and where the rear wheels (9) are straight ahead or controlled by the front steering;
b) an approach phase, where the vehicle (3) starts berthing to a pier (2), where the assistance system (1) switches to the berthing mode with the rear wheels (9) remaining in road mode as long as the front distance sensor (15) does not detect the pier (2), and where the rear wheels (9) are controlled by the assistance system (1) as soon as the front distance sensor (15) detects the pier (2), and are steered so that the rear axle (5) is moved to the pier (2);
c) a stop phase, where the vehicle (3) is berthed to the pier (2);
d) a start phase, when the vehicle (3) is leaving the pier (2), where the assistance system (1) switches to the berthing mode and the rear wheels (9) are steered so that the rear axle (5) is moved away from the pier (2);
e) a driving phase, where the vehicle (3) drives in the classical way after leaving the pier (2), with the assistance system (1) switched to the road mode and the rear wheels (9) straight ahead or controlled by the front steering.

42. The berthing process according to claim 41, wherein, in the stop phase, the rear wheels (9) are monitored to go back to a non-steered position.
